(19) United States
(12) Patent Application Publication
(10) Pub. No.: US 2006/0214419 A1
(43) Pub. Date: Sep. 28, 2006

(54) Adapter for coupling two connecting pipes

(75) Inventor: Gunnar Heuer, Horneburg (DE)

Correspondence Address: CHRISTOPHER PARADIES, PH.D., FOWLER WHITE BOGGS BANKER, P.A., 501 E KENNEDY BLVD, STE. 1900, TAMPA, FL, 33602, US

(73) Assignee: Airbus Deutschland GmbH, Hamburg (DE)

(21) Appl. No.: 11/188,361

(22) Filed: Jul. 25, 2005

(30) Foreign Application Priority Data
Jul. 23, 2004 (DE) 10 2004 035 854.0

(51) Int. Cl. F16L 41/00

(52) U.S. Cl. 285/142.1

(57) ABSTRACT

An adapter that is used for connecting pipelines of a system for liquids installed internally in an aircraft and for floor-bridging installation in an aircraft is improved to such an extent that the adapter arrangement is carried out with less labour and fewer difficulties being experienced in the installation. Preinstallation of the adapter on floor panels implement leakage-free (non-dripping and pressure-proof) connecting pipes The connecting pipes are integrated in an aircraft's internal system for liquids and are separately laid out in the interior of the aircraft, above and/or below a floor. The adapter comprises an adapter top and an adapter bottom, which are both implemented with a pipe-shaped adapter body. The latter is intended for connection to the aircraft's internal system for liquids, such as potable water or waste water. The adapter bottom comprises a first pipe that can be positioned within a recess in the floor. An attachment flange is formed to the external circumference of the first pipe, which adapter flange is attached to a lower floor region of the floor. The adapter top may comprise a pipe connection piece which can be inserted into the pipe cross section of the first pipe, wherein the external circumference of the pipe connection piece is connected, by joining, to the internal pipe wall region of the first pipe.

### RELATED APPLICATIONS

This application claims the benefit of the filing date of German Patent Application No. 10 2004 035 854.0 filed Jul. 23, 2004 to Gunnar Heuer, the disclosure of which is hereby incorporated herein by reference.

### FILED OF THE INVENTION

The field relates to an adapter for coupling connecting pipes.

### BACKGROUND

In aircraft engineering connecting pipes are often used for supplying potable water or for draining waste water, wherein the liquids which are supplied or let out necessarily have to lead through the floor of an aircraft, because the toilets and the wash- rooms are normally installed in the cabin region (passenger region) and it is in these support regions that the connection of corresponding connecting pipes will take place. Although below the floor in the cargo compartment region there are suitable collection containers for the above-mentioned liquids, apart from direct pipe routing through the floor to the above mentioned support regions, which direct pipe routing is not advantageous for service and maintenance reasons, there is only the option of a floor adaptation of the connecting pipes, wherein such a desired adaptation, however advantageous it may seem, will be subject to certain requirements and also difficulties during installation.

At present, Airbus products, in particular those in the long-range fleet, are equipped with adapter plates which comprise a rotationally symmetrical adapter top and adapter bottom, and are embedded in a floor plate. For attachment, of a known adapter used, to the floor of an aircraft, and for creating a leadthrough through said floor, a technically skilled person will refer to the attached FIGS. 7, 7a and 7b, which said person will contemplate and interpret with their accumulated specialist knowledge and experience. It should be added, because it is not clear from the figures, that attachment of the adapter top and adapter bottom within the floor panel takes place in so-called inserts with the use of screws. Furthermore, three quick-closing screws connect the adapter top with the adapter bottom. Such solutions for a potable-water connection and a waste water connection implemented as shown in the above-mentioned figures are associated with a disadvantage in that in the process of conveying potable water or waste water, isolated leakages occur which are caused by the (not particularly stable) quick-closing connections which are used for fitting the potable water or waste water connecting pipes to the adapter. There is thus a danger that the water, which will exit from the leaking positions of the adapter, can penetrate to regions situated underneath the aircraft floor, which is likely to cause safety-relevant damage.

Furthermore, installation personnel have often criticised the design of such adapter plates because fitting requires additional installation effort because final connection of the connecting pipes that are connected to the water system or to the waste water system can only take place below the floor. This measure always requires a change in the horizontal plane by the pipe installer, as a result of which the individual technological expenditure relating to time and preparation is unnecessarily increased. A further point of criticism which (in particular in aircraft engineering) deserves particular attention relates to the weight of the adapter, which weight is by no means favourable, and to the large number of parts for each coupling to be established. An observer will easily recognise the heavy weight purely by noticing the relatively large dimensions of the adapter tops and bottoms, without having to examine in detail the materials used in these adapter components. A technically skilled person versed in aircraft engineering will notice that with the use of these aforementioned adapter plates, corresponding integration problems within regions of the aircraft that are difficult to access are at first unavoidable. Such regions that are difficult to access are often encountered, not only during initial fitting out of the aircraft, but also later during service and maintenance. Thus, the installation personnel who will carry out pipe installations for the galleys and toilets of an aircraft of the type “Airbus A340” will not find any identical pipe connections which are matched to each other, because technologically different connection principles are to be observed. This practised installation technology requires a corresponding plurality of parts relating to different below-floor pipes, which plurality is to be taken into account in the connection of two connecting pipes, which connection is inevitably continued through the floor of the aircraft, and which plurality must also be taken into account in the adaptive connection of these pipes to a pipeline adapter firmly seated in the floor, as said plurality nearly doubles in such an arrangement. These disadvantages provide a technically skilled person with sufficient reason to ponder how to improve the described connection technology involving a pipeline adapter such that said technically skilled person can state a solution by means of which the advantages as set out below for coupling two connecting pipes become technologically realisable.

Accordingly, there may be a desire to improve an adapter for coupling two connecting pipes such that it will be possible to attach the adapter without significant labour outlay to an attachment surface, and so that it will be possible, with the adapter, to implement leakage-free (non-dripping and pressure-proof) adaptation of the connecting pipes, which adaptation can be carried out efficiently. In this approach, a reduction in the multitude of different connecting pipes and a reduction in the multitude of components of the adapter is to be achieved, and furthermore, the need for installation personnel to change from one horizontal plane to another during installation of the adapter is to be obviated.

### SUMMARY

With the invention, an adapter that is used in aircraft engineering is improved to such an extent that when compared with traditionally used adapters it can be attached without significant labour outlay to a floor in an aircraft, which adapter is intended for preinstallation on floor panels intended for installation. This adapter will be able to implement leakage-free (non-dripping and pressure-proof) adaptation, which can be carried out efficiently, of the connecting pipes of a system for liquids, which connecting pipes are installed inside an aircraft, wherein the exchangeability of said connecting pipes is ensured, when necessary, possibly in very confined spaces, even under climatically (more) disagreeable conditions, which exchangeability would otherwise not always be possible without significant difficulty.

For example, an adapter may be provided for coupling connecting pipes in a commercial aircraft, which connecting pipes are integrated in an aircraft's internal system for liquids and which are separately laid out in the interior of the aircraft, above and/or below a floor, which adapter comprises an adapter top and an adapter bottom, which are both implemented with a pipe-shaped adapter body for connection to a connecting pipe, wherein the connecting pipes are connected to the system for liquids through which potable water or waste water flows, wherein the adapter bottom comprises a first pipe for positioning within a recess in the floor, and wherein an attachment flange is formed to the external circumference of the first pipe, which adapter flange is attached to a lower floor region of the floor, and wherein the adapter top comprises a pipe connection piece for insertion into the pipe cross section of the first pipe, with the external circumference of the pipe connection piece being connected, by joining, to the internal pipe wall region of the first pipe.

### BRIEF DESCRIPTION OF THE DRAWINGS

The invention is described in more detail in some examples with reference to the following drawings. The following are shown:

FIG. 1 a longitudinal section view of the arrangement of a potable-water adapter, positioned in the floor, whose angled adapter bottom for a potable-water connection is attached below the floor;

FIG. 1a a top view of an attachment flange which is firmly formed to the adapter bottom according to FIG. 1;

FIG. 2 the arrangement according to FIG. 1 with a straight adapter bottom;

FIG. 2a a top view of the attachment flange without additionally showing the straight adapter bottom according to FIG. 2;

FIG. 3 a longitudinal view of the arrangement of a waste water adapter, positioned in the floor, with its angled adapter bottom for a waste water connection being attached below the floor;

FIG. 3a a top view of an attachment flange which is firmly formed to the adapter bottom according to FIG. 3;

FIG. 4 a longitudinal section view of the arrangement according to FIG. 3 with a straight adapter bottom;

FIG. 4a a top view of the attachment flange according to FIG. 4 without additionally showing the straight adapter bottom;

FIG. 5 a longitudinal section view of the arrangement of a plate nut attached to the attachment flange according to FIGS. 1, 2, 3 and 4;

FIG. 6a the top of the adapter for a potable-water connection according to FIG. 1;

FIG. 6b the top of the adapter for a waste water connection according to FIG. 2;

FIG. 7 a longitudinal section view of known adapter arrangements for a potable-water adapter and a waste water adapter, both positioned in the floor;

FIG. 7a view A according to FIG. 7 for the known adapter arrangements;

FIG. 7b a top view of the known adapter arrangements according to FIG. 7b within a cabin space.

### DETAILED DESCRIPTION

This detailed description and the drawings provide specific examples of the invention, but the invention should not be limited merely to the examples disclosed. Instead, the invention should be limited only by the claims that may eventually issue. Many variations in the system, changes in specific components of the system and uses of the system will be readily apparent to those familiar with the field based on the drawings and description provided.

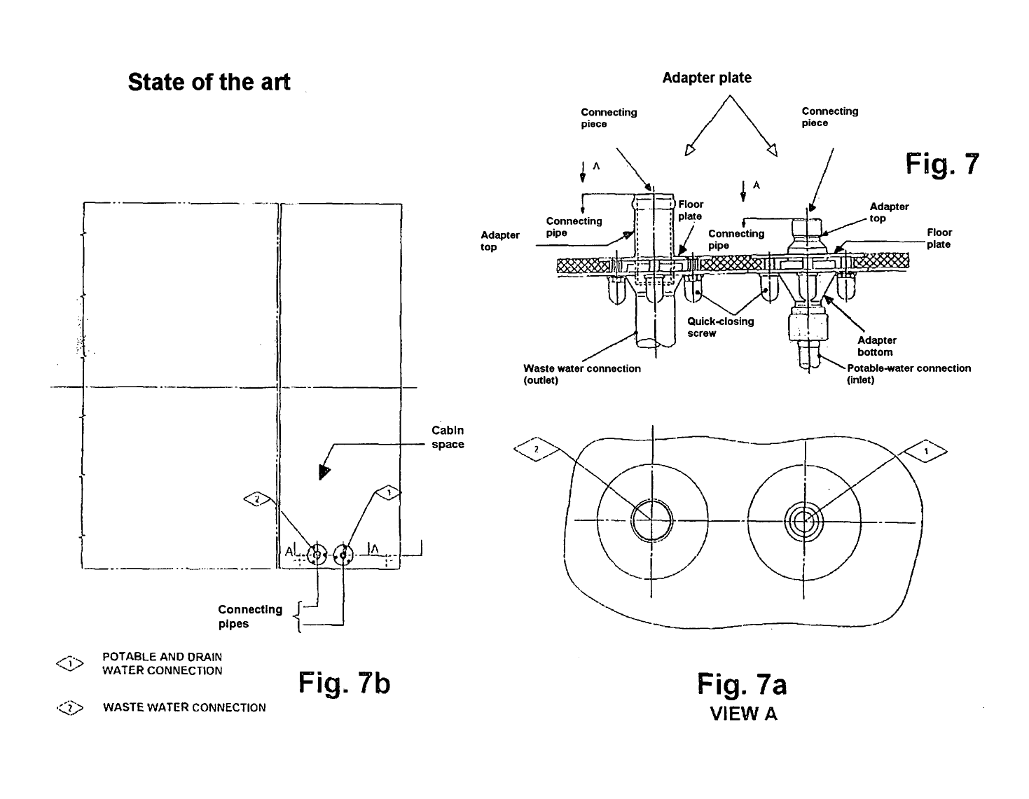

The adapter arrangements according to FIGS. 7, 7a and 7b, which a technically skilled person on closer examination will find in aircraft of the long-range fleet of the “Airbus” type, have already been discussed in detail. Said skilled person, provided s/he attempts to assess the solution according to FIG. 7 with technological yardsticks, will contemplate the labour outlay required in an involved installation of the adapter arrangements in the floor (due to the multitude of parts of the adapter used) and a (temporarily) unavoidable change of horizontal plane (from the passenger deck to the cargo compartment deck of the aircraft and vice-versa) and/or a (temporary) requirement for several persons (at least 2 installers) for a potable-water connection and/or a waste water connection. FIGS. 7a and 7b support such contemplation.

Fitting the pipeline to the adapter (the adapter top and bottom), various pipe connections are used, which have, for example, a different pipe cross-section which will have to be qualified. In the case of adapter pipe connections, desired weight savings are achieved using an adapter of the present invention which requires less material and fewer components.

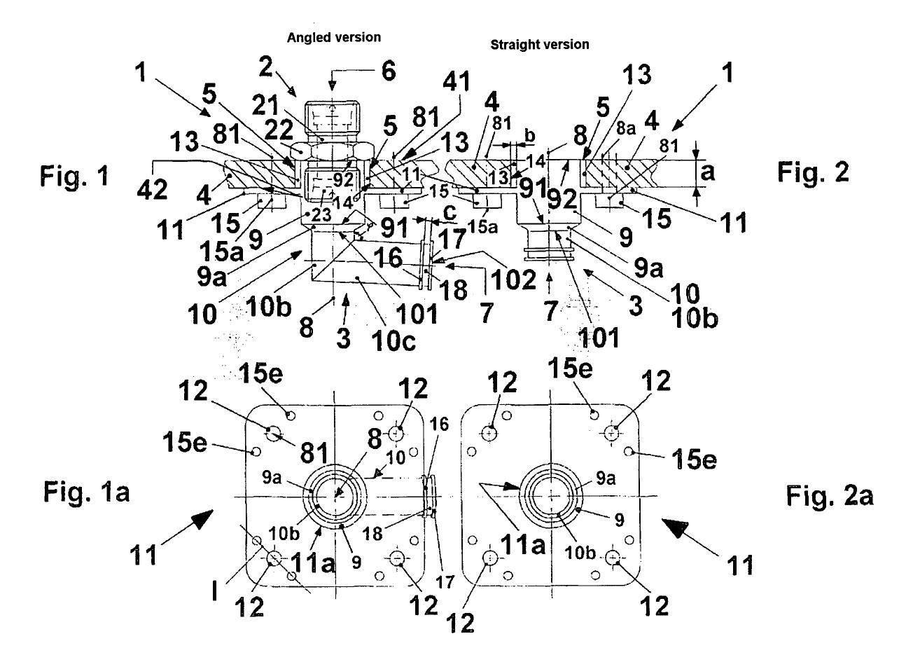

For example, an improved adapter for coupling two connecting pipes is shown in FIGS. 1, 2, 3 and 4, which when compared to the known adapter, according to FIG. 7, distinguishes itself by improvements that facilitate installation and by a reduction in the number of adapter components. Therefore, the disadvantages stated in the introduction are overcome.

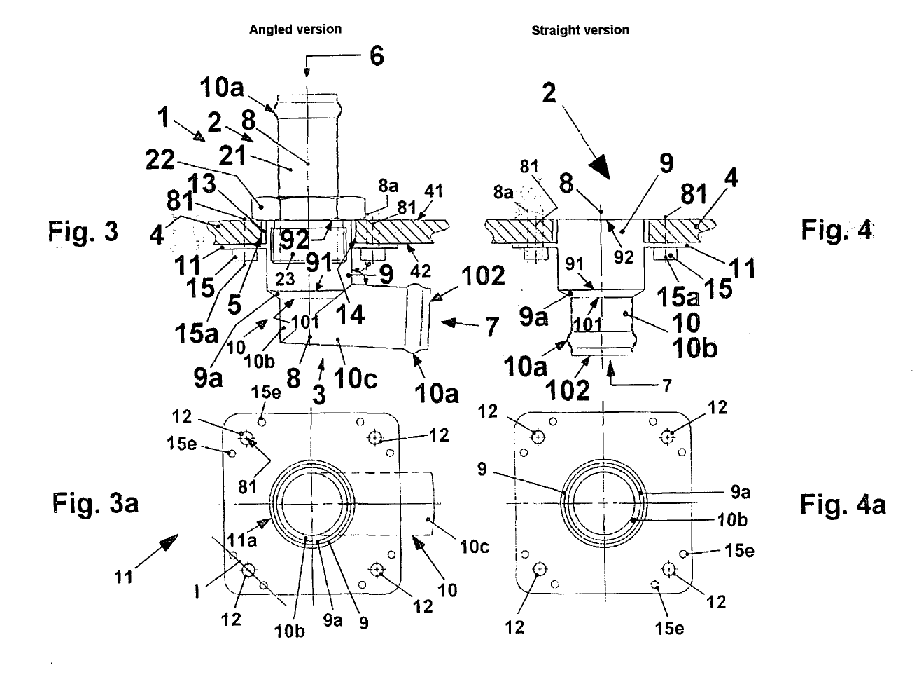

One embodiment of the adapter 1 for coupling two connecting pipes 6, 7 (pipelines) in a commercial aircraft is first superficially examined with reference to FIG. 1, which according to said Figure refers to a so-called potable-water adapter for the adaptation of potable-water pipes. This hinted-at detail of explanations will take place because the design of said potable-water adapter according to FIG. 2 differs only in detail (in relation to design and arrangement). Also a so-called waste water adapter, which is presented with reference to FIG. 3, when compared to the basic design of said potable-water adapter, differs only in detail, the design of which potable-water adapter according to FIG. 4 (concerning design and arrangement) also only differs in detail.

To return to the potable-water pipe adapter according to FIG. 1, the latter comprises an adapter top and an adapter bottom 2, 3 which (generally viewed) form a rotational body. Both adapter parts are designed such that on each connection end a connecting pipe 6, 7 (in FIG. 1 indicated by an arrow) can be adapted.

It would also be imaginable that in the pipe connection region of the adapter top and/or adapter bottom, a line branch piece (not shown in detail) can be adapted in order to indicate the possibilities of adaptation of several pipes to an adapter 1 (according to the FIGS. 1, 2, 3 and 4). Dimensioning of the connection cross sections of the adapter components in correlation with these connecting pipes will be within the expertise of the average technically skilled person. These adapted connecting pipes 6, 7, for example, use pipelines of which a first connecting pipe 6 is installed above a floor 4, and a second connecting pipe 7 is installed below the floor 4.

It is provided for the first connecting pipe 6 to be connectable to the adapter top 2, and for the second connecting pipe 7 to be connectable to the adapter bottom 3. Provided there is a circular recess 5, being a through-borehole, through the floor 4, which recess for example leads through the floor 4 so as to be perpendicular, a pipe section (leading to a second pipe end 92) of a first pipe 9 is positioned within this through-borehole, wherein joining the adapter bottom 3 (according to FIG. 1) a second pipe 10 is connected, whose second pipe end 101 is connected to the first pipe end 91 of the first pipe 9.

If considered, there is then the option of implementing adaptation on the first pipe end 102 of the second pipe 10 with a second connecting pipe 7, which is a pipeline. This second connecting pipe 7 and a first connecting pipe 6, whose adaptation is intended with the adapter top 2, are associated with a potable-water system of a commercial aircraft. For example, through these connecting pipes, corresponding quantities of potable water can be supplied to a galley area.

Adapter 1 according to FIG. 1, by way of which adapter 1 potable water is to be conveyed to a destination point (for example in the above-mentioned galley area of the aircraft), thus comprises an adapter bottom 3 with a first pipe 9, to which on a first pipe end 91 a pipe flange 9a is formed, which pipe flange 9a is drawn inward towards the pipe axis 8. Furthermore, the adapter bottom 3 comprises a second pipe 10 which with a second pipe end 101 is formed to the flange rim of an inward drawn flange region (for example directed towards the pipe axis 8) of the pipe flange 9a, wherein said flange rim circumferentially will encompass an open cross-sectional flange area whose circular circumference is determined by the interior diameter of the pipe flange 9a. The second pipe 10 of the adapter bottom 3, which is envisaged for connecting a (second) connecting pipe 7, thus comprises two pipe parts 10b, 10c, which are connected within the pipe system In this arrangement, an axial position of the pipe part axis of said first pipe part 10b is considered, which axial position corresponds to the pipe axis 8 of the first pipe 9. Furthermore, FIG. 1 shows that the first and the second pipe part 10b, 10c are arranged at an angle φ in relation to each other. If one starts with two imaginary tangents placed on the outer circumference of the pipe walls of the two pipe parts 10b, 10c angled at said angle φ in relation to each other (seen from the right hand side of the first pipe part 10b), the viewer will understand the selected extent of the angle φ, which angle φ exceeds 90 degrees. The desired angle will be matching the particular spatial arrangement, for example to provide a sufficient gradient in the second pipe part 10c for conveying the liquid.

Furthermore, an attachment flange 11, whose flange surface is square, in the middle of said flange surface comprises a central borehole through which the first pipe 10 leads perpendicularly to the flange surface. In this arrangement, the attachment flange 11 is formed, on the external circumference, to the first pipe 9 (i.e. formed to the wall of said first pipe 9) in the region of the central borehole.

This attachment flange 11 is attached to the external diameter (approximately) at a space a of the second pipe end 92 of the first pipe 9 (as shown in FIG. 2), wherein the space a approximately corresponds to the thickness of the floor 4.

The attachment flange 11 is shown in top view in FIG. 1a, wherein said attachment flange 11—also viewed in correlation with FIG. 2a—comprises several flange boreholes 12 which are situated on an imaginary hole circle (not shown). These flange boreholes 12 are needed in order to implement (with a view to FIG. 1) the intended fixed and disconnectable connection (and indirect connection) of the attachment flange 11 to the lower floor region 42 of the floor 4 with screws (not shown). It is understood that the diameter of this imaginary hole circle will be larger than the diameter of a central borehole 10b of the attachment flange 11.

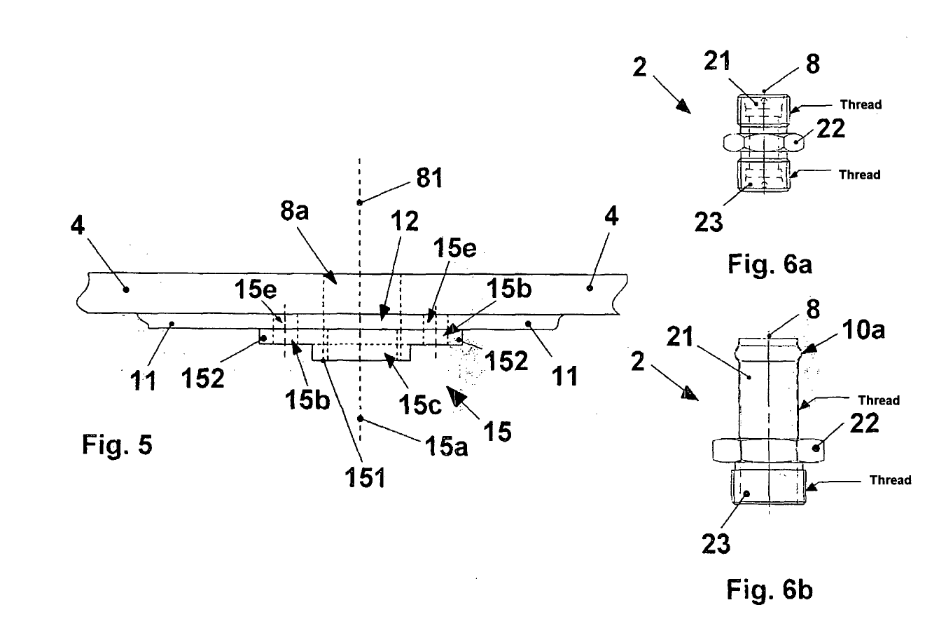

So that the attachment flange 11 can be attached to the floor 4 using the screws (through-screws) the floor 4 comprises several floor boreholes 8a (not referenced in FIG. 1, but clearly shown in FIG. 5) which are aligned so as to be perpendicular in relation to the floor 4, with the borehole diameter and the position of said floor borehole 8a, which position corresponds to the borehole axis 81 (of the floor borehole 8a according to FIG. 5), being identical to the borehole diameter and the position of the flange boreholes 12, provided the first pipe 9 is positioned within the recess 5, and the attachment flange rests against the floor surface below the floor 4.

An air gap 13 may be located between a free wall region 14 of the circular recess 5 (i.e. between a free wall of a borehole of the floor 4) and the external region of the pipe wall of the first pipe 9, which pipe 9 is positioned within this recess 5. In order to tightly seal the floor 4, the gap 13 may be filled with a moisture repellent adhesive, such as a silicon-like adhesive, which provides adequate adhesion to the surface of the first pipe 9 and to the borehole wall of the floor 4. Any adhesive or filler may be used to seal this gap 13 including bushings, adhesives and the like.

The above-mentioned screws (through-screws), which are inserted above the floor 4 into those floor boreholes 8a and which lead through the latter as well as through the above-mentioned flange boreholes 12 on the rim side of the attachment flange 11, may be screwed to respective plate nuts 15, as shown in FIG. 1, which are arranged below said flange boreholes 12. As a result of which the square resting surface or supporting surface of the attachment flange 11 may be (detachably) attached to the four marginal corner regions in the lower floor region 42. The screw attachment can be carried out without any particular expenditure provided the centre of the thread of the plate nut 15 is arranged so as to coincide with the centre of the respective flange borehole 12. The above-mentioned plate nut 15 is for example implemented with a square sheet metal body 151 (shown in FIG. 5), to which in each case, on two opposite body edges, a lug 152 with a rivet borehole 15b in the centre of the lug is formed.

In this arrangement, in the middle of the sheet metal body 151 a threaded borehole 15c is arranged to which the above-mentioned attachment screws are screwed (with the use of adequate tightening torque). The screw connection is established so that the position of the borehole axis 81 of the single floor—and flange borehole 8a, 12 corresponds to the position of a plate nut—hole thread axis 15a of the threaded borehole 15c. Furthermore, at the rim side of the single flange borehole 12 two additional boreholes 15e, positioned on a line I (shown in FIG. 1a) are bored in the attachment flange 11, wherein this line 1 is an imaginary line placed on the borehole centre of the respective flange borehole 12, wherein the position of the rivet borehole 15b in the centre of the lug is identical to the position of this additional borehole 15e. The lugs 152 of the sheet metal body 151 are attached to the attachment flange 11 with a rivet each (not shown in FIGS. 1 and 5), which rivet leads through the respective rivet borehole 15b in the centre of the lug and through the additional borehole 15e which communicates with said rivet borehole 15b.

FIGS. 1 and 1a further show that a first and a second ring-like elevation 16, 17 are arranged on one pipe end region of the second pipe 10, which pipe end region extends to a remaining first pipe end 102 of said pipe 10. These two elevations 16, 17, which have been implemented for example by a ring body which is formed to the second pipe 10 on its external circumference, are arranged (lying) side by side at a spacing c, so that between these elevations 16, 17, around the circumference of the pipe a groove 18 is enclosed, which has been provided so that it can be coupled to a second connecting pipe 7 (indicated in the figure by an arrow) with a quick-acting pipe closure (not shown in the figure). Other fasteners or attachments may be used in embodiments of the present invention that likewise provide advantages.

To return to FIG. 1, the adapter top 2 comprises a pipe connection piece and a locknut 22, wherein said locknut is formed to the pipe connection piece on the external circumference. As a result of the arrangement of the locknut 22 on the pipe connection piece, wherein said locknut 22 is preferably formed approximately in the middle of the pipe to the external diameter, the pipe connection piece is divided into a first pipe connection part 21 and a second pipe connection part 23. Generally, it is intended that the second pipe connection part 23 can be inserted into the (open) pipe cross section of the first pipe 9, and that the pipe connection piece on the external circumference is connected with the inside pipe wall region of the first pipe 9 by joining. These general observations take into account that joining results in a joining connection which is a fixed connection implemented in such a way that the external circumference of the pipe connection piece, by way of a length of pipe connection piece which is inserted into the pipe cross section of said first pipe 9, will be detachably connected to the interior pipe wall region of the first pipe 9. For example, it is provided for the detachable joining connection to be implemented with a direct screw connection. This screw connection is for example to be designed such that an external thread of the pipe connection piece can be screwed (is able to be screwed) to the internal thread of the first pipe 9. The intention is to create a joining connection, established by a joining action, which joining connection is implemented with an almost positive-locking connection. This positive-locking connection is designed in such a way that the external circumference of the pipe connection piece, by way of a stretched length of the pipe connection piece which is inserted in the pipe cross section of the first pipe 9, rests in a non-slip way against the interior pipe wall region of the first pipe 9. It is therefore imaginable that in addition, on the external circumference of the pipe connection piece, the external thread of the pipe connection piece is arranged, coated with a rubber-like seal or an organic plastic coating that provides sealing action and non-slip and abrasion-resistant characteristics, by means of which external thread a positive-locking joining connection is implemented.

In relation to the embodiment according to FIG. 1, it is further stated that in the interior of the first pipe 9 on the pipe wall, there is an internal thread which commences at (or near) the second pipe end 92 of the first pipe 9, and which is arranged so as to be aligned in the direction of the pipe axis 8 of the first pipe 9 (it is imaginable right through to the first pipe end 91).

In contrast to this, the first and/or the second pipe connection part 21, 23 comprise(s) an external thread so that, as shown in the exemplary embodiment, the second pipe connection part 23 can be screwed onto the internal thread of the first pipe 9. If, as stated, said second pipe connection part 23 is screwed to the first pipe 9 (at the second pipe end 92 which provides a seal in the upper floor region 41), a fixed and detachable mechanical joining connection is achieved.

If the first pipe connection part 21 of the pipe connection also comprises an external thread around the circumference of the pipe, it is possible to detachably attach this first pipe connection part 21 to a screw-on pipe (connection) end of a first connecting pipe 6. Otherwise it is also imaginable that an end region of the pipe connection of the first pipe connection part 21, which end region extends to its free pipe connection end, according to the above-mentioned design of the end region of the second pipe 10, on the circumference comprises a further groove which includes two further ring-like elevations, or in the alternative, according to the model explained, comprises a further flanging, near the free end of the first pipe connection part 21, such that said end region of the pipe connection of the first pipe connection part 21 is suitable for connection to said first connecting pipe 6.

In summary, it is intended for the adapter bottom 3 (i.e. the internal thread of the first pipe 9) to be screwed together with the adapter top 2 (i.e. that external thread of the second pipe connection part 23), wherein advantageously the first connecting pipe 6 can be adapted to the non-screwed end region of the first pipe 9 by means of a further quick-acting pipe closure, provided the end region of the connecting pipe 6 comprising a pipe is designed according to the model of the second pipe 10, for example with two side-by-side ring-like elevations 16, 17.

It should be mentioned that the use of said locknut formed to the pipe connection is (in particular) needed for the desired purpose, in vehicle engineering or aircraft engineering, because through a conveyed counter moment which is implemented with a torque on the rotary axis 8 of the pipe connection piece, and which is converted to a mechanically-achieved clamping action on the circumference of the second pipe end 92 of the cross section of the first pipe 9, unintended undoing of the joining connection is avoided, or such unintended undoing is preventatively encountered, which torque, for reasons of safety, is transmitted to the locknut 22 and which is supported by any further mechanically acting safety devices which are not discussed in detail. In any other remaining application cases, this locknut may not necessarily have to be installed on the pipe connection piece.

FIG. 2 shows a modified embodiment of the adapter 1 according to FIG. 1 which relates to a potable-water adapter which is converted to a straight pipe outlet of the second connecting pipe intended for adaptation. This potable-water adapter differs from the one shown in FIG. 1 in that only the second pipe 10 of the adapter bottom 3 is used for connection to a (second) connecting pipe 7. Unlike the design of the second pipe 10 according to FIG. 1, which design comprises a pipe system comprising a first and a second pipe part 10b, 10c arranged at an angle φ in relation to each other, in the exemplary embodiment according to FIG. 2 only the first pipe part 10b is considered, wherein the position of the pipe part axis of said first pipe part 10b corresponds to the pipe axis 8 of the first pipe 9. FIG. 2 also lacks the adapter top 2 (which is included in FIG. 1), which is implemented with a pipe connection piece (in FIG. 1 shown in the screwed-in state in the first pipe 9) to which connection piece a locknut 22 is formed on the pipe circumference. In this arrangement the end region of the first pipe 9, which comprises a pipe section of a defined length extending to the (free) pipe end, is arranged in a way different from that second pipe end 101 which is formed to the inward drawn pipe flange 9a. This pipe end region is designed as shown in FIGS. 1 and 1a, wherein near the end region of the pipe and around the circumference of the first pipe part 10b an additional further groove is arranged which includes two additional further ring-like elevations. This provides the option of coupling a second connecting pipe 7 (in the figure indicated by an arrow) to said pipe end region by means of a quick-acting pipe closure. As an alternative there is also the option, for coupling a (second) connecting pipe 7 near the end of the second pipe 10, of considering an additional further flanging which is designed as shown in FIG. 4 and whose design is discussed below. The design of this additional flanging will be explained below. The representation of the attachment flange 11 according to FIG. 2a essentially corresponds to that according to FIG. 1a. This representation does not show the dashed alignment of the second pipe part 10c and its design on the pipe end comprising a groove, because this second pipe part 10c is not being considered in correlation with the embodiment according to FIG. 2.

FIG. 3 shows a modified embodiment of the adapter 1 according to FIG. 1, which embodiment relates to a waste water adapter. That adapter 1 also comprises a straight pipe outlet, implemented with the first pipe 9, wherein that inward-drawn pipe flange 9a which is connected to the second pipe 10 is formed to the first end of the first pipe. In this arrangement the first pipe part 10b is connected (by joining) to the second pipe end 101 of the second pipe 10 of the pipe wall (which pipe wall encloses the open pipe cross section) of the inward-drawn pipe flange 9a. It should be mentioned that the first pipe part 10b (as shown in FIG. 1) is connected to the second pipe part 10c and is also angled at the above-mentioned angle φ. The design of said pipe end section of the second pipe part 10c differs from the embodiment according to FIG. 1 in that, as indicated above in the context of another imaginable embodiment, a flanging 10a is arranged near the pipe end of the second pipe part 10c, which is why said pipe end section comprising flanging 10a is suitable for coupling with the second connecting pipe 7.

The embodiment, shown in FIG. 4, of the adapter bottom 3 for the waste water adapter is similar to the embodiment according to FIG. 2 for a potable-water adapter. The two embodiments differ in the modification of the pipeline end section of said second pipe 9, according to which, instead of the groove 18 shown in FIG. 2, the flanging 10a (as shown in FIG. 3) of the straight first pipe 9, which flanging 10a is situated near the pipe end (i.e. near the first pipe end 102), is arranged. In this way, the pipeline end of the straight first pipe 9, which pipeline end has been made in this way, is also suitable for coupling with the second connecting pipe 7.

FIGS. 3a and 4a are a top view of the attachment flange 11 shown in FIGS. 3 and 4. It should be mentioned that these representations are identical to those in FIGS. 1a and 2a as the same type of attachment flange 11 is considered for attachment of the adapter bottom 3 to the lower floor region 42. The existing differences concerning the two representations according to FIGS. 3a and 4a again only relate to that part of the design which concerns the shown region of that pipe which is connected to the inward-drawn flange 9a. Thus, the top view according to FIG. 3a shows the dashed arrangement (position) of the second pipe part 10c of the second pipe 10, whereas the top view according to FIG. 4a does not show this dashed arrangement (position) of the second pipe part 10c because in correlation with FIG. 4 only the second pipe 10, which comprises the first pipe part 10b, is connected to the inward-drawn flange 9a.

It should be added to the above explanations concerning FIG. 1a (and in correlation with FIG. 2a) that, as shown in FIGS. 3a and 4a, the attachment flange 11 comprises several flange boreholes 12 arranged on an imaginary hole circle. These flange boreholes 12 are for screw-type attachment (for disconnectable firm connection) of the attachment flange 11 to the lower floor region 42 of the floor 4 by means of screws 15.

It is understood that this screw-type attachment can only be effected if the centre of this imaginary hole circle corresponds to that of the central borehole 11a. The diameter of the imaginary hole circle too will be larger than the diameter of the central borehole 11a. It should be added that on the rim side of the single flange borehole 12 there are two additional boreholes 15e drilled on a line I in the attachment flange 11. The line 1 has been placed as an imaginary line on the borehole centre of the respective flange borehole 12. This information equally applies to any of the attachment flanges 11 shown in the figures. Any other fastener or attachment system may be used in alternative embodiments.

FIGS. 1, 2, 3 and 4 show that underneath each of the flange boreholes 12 a plate nut 15 is arranged which is attached flat to the floor 4. In this arrangement a plate nut—hole thread axis 15a of the plate nut 15 and a borehole axis 81 of the flange borehole 12 are arranged so as to coincide. As shown in FIG. 5, said plate nut 15 is implemented with a square sheet metal body 151 as shown in the exemplary embodiment, wherein a lug 152 each, comprising a rivet borehole 15b in the centre of the lug, is formed to said sheet metal body 151 on two opposite edges of the body. A threaded borehole 15c is positioned in the centre of the sheet metal body 151, wherein the position of the borehole axis 81 of the single floor borehole and flange borehole 8a, 12 coincides with the position of a plate nut—hole thread axis 15a of the threaded borehole 15c. The position of the rivet borehole 15b is identical with that of said additional borehole 15e. The lugs 152 of the sheet metal body 151 are connected to the attachment flange 11 using a rivet each (not shown in the figures), wherein said rivet is led through the respective rivet borehole 15b in the middle of the lug and through the additional borehole 15e which communicates with said rivet borehole 15b.

FIG. 6a shows the adapter top 2, shown in FIG. 1, for a potable-water adapter, while FIG. 6b shows the adapter top 2, shown in FIG. 3, for a waste water adapter. The design of said adapter top 2 is also generally described with reference to FIGS. 1 and 3. It should be added that both adapter tops 2 (of different design) are implemented with a pipe connection piece and a locknut 22 formed to the pipe circumference. When compared to the design according to FIG. 6a, the design of the adapter top, shown in FIG. 3 and individually shown in FIG. 6b, for a waste water adapter 2 differs in that the length of the pipe of the second pipe connection part 23 is shorter than the length of the pipe of the first pipe connection part 21 so that the locknut 22 is arranged closer to the pipe-side (free) end on the pipe of the second pipe connection part 23. Furthermore, near the pipe-side (free) end of the pipe of the first pipe connection part 21, as shown in the exemplary embodiment, there is a flanging 10a (or bead) so that here too adaptation of a first connecting pipe 6 can take place (as shown in FIG. 3).

These details are supplemented by the following information, provided this has not already happened in the functional context (according to design and operation) for a potable-water adapter or a waste water adapter as shown by the examples of said figures.

The recess 5 made in the floor 4 is preferably a borehole, wherein cross sectional shapes which differ from that of the recess 5 are imaginable.

In a way that is different from the perpendicular opening through the upper floor region 41 of the floor 4, this recess 5 can also be made so as to penetrate the floor 4 at an inclined angle, wherein this latter measure is only imaginable when an adapter top 2 without a locknut 22 is used.

As a rule, the above-mentioned second pipe end 92 of the first pipe 9 is closed off in the upper floor region 41 of the floor 4. Furthermore, if required, an embodiment would be imaginable wherein said second pipe end 92 is spaced apart from this upper floor region 41 of the floor 4, provided the first pipe 9 leads to the outside of the recess 5.

It should be mentioned that the external circumferential pipe diameter of the first and the second pipe 9, 10 can differ from each other, wherein this measure will need to be matched to the respective desired system requirements. Similarly, the flanging 10a and/or the (previously stated) further flanging according to the FIGS. 3, 4 and 6a for a waste water adapter can be replaced by a bead.

As mentioned above, the flange disc of the attachment flange 11 comprises a central borehole 11a through which the first pipe 9 leads. This central borehole 11a is arranged in the region of the recess 5 in the floor 4 so as to be (almost) positionally accurate. It should be added that the attachment flange 11 (if the flange disc rests against the floor) is arranged approximately at the pipe spacing a, which starts at the second pipe end 92 of the first pipe 9 and corresponds to at least the thickness of the floor 4, at which location said attachment flange 11 is formed to the external circumference of the first pipe 9. The shape of the flange disc is preferably square; however, a circular or oval shape or other shapes of the flange disc can also be possible.

The internal thread of the pipe, which starts at least on the second pipe end 92 of the first pipe 9 and continues along the inward pipe wall region of the first pipe 9 of said adapter bottom 3 in the direction of the pipe axis 8 of the first pipe 9, is designed such that it can be screwed to the first pipe end 91 of the first pipe 9, i.e. it is continued in this direction.

Furthermore, the second pipe 10 of said aforementioned adapter bottom 3 comprises a first pipe part 10b which is given by a pipe section of the second pipe 9 of a defined pipe length for the first pipe part 10b. The start of this defined pipe length is determined starting on the second pipe end 101 of the second pipe 10, which in the end state is connected (joined) to the flange rim of the inward-drawn flange 9a. As shown in FIGS. 1 and 3, at the end of the defined pipe length of the first pipe part 10b, a second pipe part 10c, which is given by a further pipe section of the second pipe 9 of remaining (finite) pipe length for the second pipe part 10c, is arranged at an angle. It is imaginable that the second pipe part 10c is arranged at an angle φ of approximately 90° to 179° in relation to the first pipe part 10b. Preferably, the angle φ is approximately 93°.

### LIST OF REFERENCES CHARACTERS

1 Adapter
2 Adapter top; connection piece with formed-on locknut 22
21 First pipe connection part
22 Locknut
23 Second pipe connection part
3 Adapter bottom
41 Upper floor region
42 Lower floor region
4 Floor region
5 Recess (in the floor 4), circular cylindrical
6 Connecting pipe, first; pipe
7 Connecting pipe, second; pipe
8 Pipe axis
8a Floor borehole (of the floor 4)
81 Borehole axis (of the floor borehole 8a)
9 First pipe (of the adapter bottom 3)
91 First pipe end (of the first pipe 9)
92 Second pipe end (of the first pipe 9)
9a Pipe flange, inward-drawn, angled
10 Second pipe (of the adapter bottom 3)
10a Flanging; bead (on the second pipe 10)
10b First pipe part (of the second pipe 10)
10c Second pipe part (of the second pipe 10)
101 Second pipe end (of the second pipe 10)
102 First pipe end (of the second pipe 10)
11 Attachment flange, square
11a Central borehole (of the attachment flange 11)
12 Flange borehole (of the attachment flange 11)
13 Gap
14 Wall region, free (of the recess 5)
15 Plate nut
151 Sheet metal body (of the plate nut 15)
152 Lug (attached to the sheet metal body 151)
15a Plate nut—hole thread axis (of the plate nut)
15b Rivet borehole (of the lug 152)
15c Threaded borehole (of the sheet metal body 151)
15e Additional borehole (of the attachment flange 11)
16 First elevation, ring-like
17 Second elevation, ring-like
18 Groove
a Pipe spacing (of the first pipe)
c Pipe spacing (between the elevations 16, 17)
l Line
φ Angle

1. An adapter for coupling connecting pipes in an aircraft, wherein the connecting pipes are integrated in an aircraft's internal system for liquids and which are separately laid out in the interior of the aircraft,
the adapter comprising an adapter top and an adapter bottom, each of the adapter top and the adapter bottom having a pipe-shaped, adapter body the adapter body of the adapter bottom comprises an attachment flange formed on an external circumference of the adapter body, the attachment flange is capable of being attached to a surface of the interior of the aircraft, and the adapter body of the adapter top comprises a pipe connection portion for insertion into a pipe cross section of the adapter bottom the external surface of the pipe connection portion being capable of coupling with an internal wall of the adapter body of the adapter bottom.

2. The adapter of claim 1, wherein the coupling of the pipe connection portion is capable of being joined as a fixed connection such that the external surface of the pipe connection portion is connected to a stretched length of the pipe connection portion capable of being inserted and detachably coupled to the interior wall of the adapter body of the adapter bottom.

3. The adapter of claim 2, wherein the pipe connection portion includes an external thread capable of being screwed into an internal thread of the interior wall of the adapter body of the adapter bottom.

4. The adapter of claim 1, wherein the coupling of the pipe connection portion, rests the external surface of the pipe connection portion in a non-slip way against the interior wall of the adapter body of the adapter bottom.

5. The adapter of claim 4, wherein the pipe connection portion has a rubber-like seal or an organic plastic coating on the external surface of the pipe connection portion such that sealing action and non-slip characteristics, provides a positive-locking coupling.

6. The adapter of claim 3, wherein the pipe connection portion has a locknut formed on the exterior surface of pipe connection portion proximally located before the start of the external thread, the external thread extending away from the locknut on the surface of the pipe connection portion.

7. (canceled)

8. (canceled)

9. The adapter of claim 1, wherein the adapter body of the adapter bottom is formed by a first pipe and a second pipe is connected to the first pipe such that a one-piece pipe adapter body is formed.

10. The adapter of claim 9, wherein an external diameter of the first pipe is greater than an external diameter of the second pipe.

11. The adapter of claim 9, wherein the second pipe has a first ring-like elevation and a second ring-like elevation arranged side by side with a gap there between and proximally disposed at an end portion of the second pipe.

12. The adapter of claim 1, wherein the attachment flange comprises a central borehole through which the first pipe leads, attachment flange being proximally located and attached at the end of the first pipe, the length of the first pipe equalling at least the thickness of the floor.

13. The adapter of claim 1, wherein the shape the attachment flange has a disc shape selected from the group of shapes consisting of circular or oval, and square.

14. The adapter of claim 1, wherein a pipe flange drawn inward towards the pipe axis is formed to a first pipe end of the first pipe, and a second pipe end of the second pipe is formed to the internal diameter of the pipe flange of the inward-drawn flange.

15. The adapter of claim 1, wherein the attachment flange has several boreholes situated equidistant from a central point, the boreholes the distance being selected such that the boreholes are capable of mounting the attachment flange to a structure in the aircraft using screws.

16. (canceled)

17. The adapter of claim 2, wherein the pipe connection portion is detachably coupled using an indirect screw connection.

18. The adapter of claim 1, wherein a wall of the borehole and the first pipe define a recess, and the recess is filled with a moisture repellent adhesive, after the first pipe is positioned and attached in the borehole.

19. The adapter of claim 18, wherein the adhesive is of a water repellent silicon-like adhesive.

20. The adapter of claim 15, wherein underneath each of the flange boreholes a plate nut is arranged and is attached to the floor, the plate nut having a plate nut—hole thread axis, and the flange borehole having a borehole axis, the axes being arranged so as to coincide.

21. The adapter of claim 20, wherein the plate nut has a square sheet metal body, the metal body is formed to a lug on two opposite edges of the body, each lug comprising a rivet borehole in the center of the lug, and a threaded borehole is positioned in the center of the sheet metal body, wherein the position of the borehole axis of the single floor borehole and flange borehole coincides with the position of a plate nut—hole thread axis of the threaded borehole.

22. The adapter of claim 21, wherein at a rim side of the single flange borehole two additional boreholes, positioned on a line, are bored in the attachment flange, the line being an imaginary line placed on the borehole center of the respective flange borehole, the position of the rivet borehole in the center of the lug being identical to the position of this additional borehole, and the lugs of the sheet metal body are attached to the attachment flange with a rivet each, the rivet leading through the respective rivet borehole in the center of the lug and through the additional borehole which communicates with the rivet borehole.

23. The adapter of claim 3, wherein the internal thread continues in the direction of the pipe axis of the first pipe, which starts at least on the second pipe end of the first pipe and continues to a first pipe end of the first pipe.

24. The adapter of claim 6, wherein the locknut divides a first pipe connection portion from a second pipe connection portion.

25. The adapter of claim 24, wherein the locknut is proximally located at the middle of the the first pipe connection portion and the second pipe connection portion.

26. The adapter of claim 6, wherein the external surfaces of the first pipe connection portion and the second pipe connection portion have an external thread, such that the second pipe connection portion is connectable by screwing it into an internal thread of the adapter body of the adapter bottom, and the first pipe connection portion is connectable by screwing it into an end of a connecting pipe.

27. The adapter of claim 11, wherein an end portion of the first pipe comprises a pair of ring-like elevations defining a space there between or comprises a flange such that the one-piece pipe adapter body is capable of being attached to a connecting pipe.

28. The adapter of claims 27, wherein the end portion of the first pipe comprises a pair of ring-like elevations.

29. (canceled)

30. (canceled)

31. (canceled)

32. (canceled)

33. (canceled)

34. An adapter for use in an aircraft for connecting a first pipe to a second pipe through a structure of the aircraft, the adapter comprising:
a mounting flange capable of being mounted to the structure at a borehole through the structure;
an adapter body comprised of a first end portion having an inner diameter and an axial direction, the first end portion being attached to the mounting flange;
a second end portion having an inner diameter less than the inner diameter of the first end portion and an axial direction at an angle to the first end portion, the second end portion having a pair of annular elevations proximally located at an end distal to the transitional portion;
and a transitional portion attaching the first end portion to the second end portion.

35. The adapter of claim 34, wherein the angle is at least 90°.

36. The adapter of claim 35, wherein the angle is no greater than 179°.

37. The adapter of claim 36, wherein the angle is 93°.

38. The adapter of claim 34, wherein the pair of annular elevations are beads.

39. The adapter of claim 34, wherein the first mating connector has an external threaded region.

40. The adapter of claim 35, wherein the first end portion of the adapter body has an internally threaded region.

41. The adapter of claim 35, wherein the second mating connector has an externally threaded region.

42. The adapter of claim 41, wherein the first mating connector has an externally threaded region.

43. The adapter of claim 42, wherein a locking nut is between the first mating connector and the second mating connector.

44. The adapter of claim 34, wherein the second mating connector has flanging or a bead.

45. The adapter of claim 44, wherein the second mating connector has a bead.
